(19) United States
(12) Patent Application Publication
(10) Pub. No.: US 2005/0014055 A1
(43) Pub. Date: Jan. 20, 2005

(54) System and method for fuel mixing in a fuel cell

(76) Inventors: Chenggang Xie, Phoenix, AZ (US); Joseph W. Bostaph, Gilbert, AZ (US)

Correspondence Address: MOTOROLA, INC.;CORPORATE LAW DEPARTMENT, SUITE R3163 PO BOX 10219, SCOTTSDALE, AZ, 85271-0219, US

(21) Appl. No.: 10/621,651

(22) Filed: Jul. 16, 2003

(51) Int. Cl. H01M 8/04; B01F 13/02

(52) U.S. Cl. 429/34; 366/101; 429/17

(57) ABSTRACT

A system and method for controlling or otherwise effectively managing fuel mixing and/or transport in a fuel cell device comprises inter alia a fuel mixing chamber (100), a pure fuel inlet line (110), a bubbling line (120) and a dilute fuel outlet line (130). Disclosed features and specifications may be variously adapted or optionally modified to control or otherwise optimize the rate and/or uniformity of fuel mixing in any fuel cell system. Exemplary embodiments of the present invention may be readily integrated with other existing fuel cell technologies for the improvement of device package form factors, weights and other manufacturing and/or device performance metrics.

### FIELD OF INVENTION

The present invention generally concerns fuel cell technology. More particularly, the present invention involves a system and method for controlling or otherwise managing fuel mixing in the operation of a fuel cell device.

### BACKGROUND OF THE INVENTION

Fuel cells are electrochemical cells in which a free energy change resulting from a fuel oxidation is converted into electrical energy. The earliest fuel cells were first constructed by William Grove in 1829 with later development efforts resuming in the late 1930's with the work of F. T. Bacon. In early experiments, hydrogen and oxygen gas were bubbled into compartments containing water that were connected by a barrier through which an aqueous electrolyte was permitted to pass. When composite graphite/platinum electrodes were submerged into each compartment and the electrodes were conductively coupled, a complete circuit was formed and redox reactions took place in the cell: hydrogen gas was oxidized to form protons at the anode (e.g., “hydrogen electrode”) and electrons were liberated to flow to the cathode (e.g., “oxygen electrode”) where they subsequently combined with oxygen.

Since that time, interest in the development of viable commercial and consumer-level fuel cell technology has been renewed. In addition to various other benefits compared with existing conventional methods, fuel cells generally promise improved power production with higher energy densities. An additional advantage of fuel cells is that they are intrinsically more efficient than methods involving indirect energy conversion. In fact, fuel cell efficiencies have been typically measured at nearly twice those of thermo-electric conversion methods (i.e., fossil fuel combustion heat exchange).

With respect to portable power supply applications, fuel cells function under different principles as compared with standard batteries. As a standard battery operates, various chemical components of the electrodes are depleted over time. The battery is an energy storage device. In a fuel cell, however, as long as fuel and oxidant are continuously supplied, the cell's electrode material is generally not consumed and therefore will not run down or require recharging or replacement.

One class of fuel cells currently under development for general consumer use are hydrogen fuel cells, wherein hydrogen-rich compounds are used to fuel the redox reaction. As chemical fuel species are oxidized at the anode, electrons are liberated to flow through the external circuit. The remaining positively-charged ions (i.e., protons) then move through the electrolyte toward the cathode where they are subsequently reduced. The free electrons combine with, for example, protons and oxygen to produce water—an environmentally clean by product.

Direct Methanol Fuel Cell (DMFC) uses diluted methanol solution as fuel, which would greatly simplify the system; however, as the dimensions of the fuel reservoir becomes smaller, mixing of fuel components generally becomes dominated by diffusion. Broad application of fuel cell technology to inter alia portable consumer-level devices presents previously unresolved problems with respect to this issue of fuel mixing. Accordingly, a representative limitation of the prior art concerns the effective and efficient delivery and mixing of fuel components during the operation of a fuel cell device.

### SUMMARY OF THE INVENTION

In various representative aspects, the present invention provides inter alia a system and method for controlling, or otherwise effectively managing, the mixing of fuel components in the operation of a fuel cell device. In one exemplary aspect, the present invention provides a fuel mixing chamber, a pure fuel inlet line, a returned air/water line from cathode, a diluted fuel outlet line to anode and a return fuel line from anode. Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative elements, operational features, applications and/or advantages of the present invention reside inter alia in the details of construction and operation as more fully hereafter depicted, described and claimed—reference being had to the accompanying drawings forming a part hereof, wherein like numerals refer to like parts throughout. Other elements, operational features, applications and/or advantages will become apparent to skilled artisans in light of certain exemplary embodiments recited in the detailed description, wherein:

FIG. 1 representatively illustrates a schematic diagram corresponding to a fuel mixing chamber of a fuel cell device in accordance with an exemplary embodiment of the present invention.

Those skilled in the art will appreciate that elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms ‘first’, ‘second’, and the like herein, if any, are used inter alia for distinguishing between similar elements and not necessarily for describing a sequential or chronological order. Moreover, the terms front, back, top, bottom, over, under, along and the like in the Description and/or in the claims, if any, are generally employed for descriptive purposes and not necessarily for comprehensively describing exclusive relative position. Skilled artisans will therefore understand that any of the preceding terms so used may be interchanged under appropriate circumstances such that various embodiments of the invention described herein, for example, are capable of operation in other orientations than those explicitly illustrated or otherwise described.

### DETAILED DESCRIPTION OF EXEMPLARY EMBODIMENTS

The following descriptions are of exemplary embodiments of the invention and the inventor's conception of the best mode and are not intended to limit the scope, applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

Various representative implementations of the present invention may be applied to any system for controlling or otherwise managing the mixing of fuel components in a fuel cell system. Certain representative implementations may include, for example: controlling the concentration of fuel in a fuel cell solution; controlling the concentration of gaseous phase chemical species in a fuel cell solution; or controlling the rate of elimination of exhaust gases from a fuel cell. As used herein, the terms “delivery” and “transport”, or any variation or combination thereof, are generally intended to include anything that may be regarded as at least being susceptible to characterization as or generally referring to the movement of at least one chemical compound from one area to another area so as to: (1) relatively decrease the concentration in or around one area, and/or (2) relatively increase the concentration in or around another area. The same shall properly be regarded as within the scope of the present invention. As used herein, the terms “fuel”, “fluid” and “solution”, or any variation or combination thereof, are generally intended to include any anode fuel solution and/or cathode oxidant solution whether or not the solution has been pre-conditioned or post-conditioned with respect to exposure to a fuel cell's electrode elements.

A detailed description of an exemplary application, namely the method of quickly mixing fuel to the desired concentration, is provided as a specific enabling disclosure that may be generalized by skilled artisans to any application of the disclosed system and method for controlling fuel mixing and/or transport in any type of fuel cell in accordance with various embodiments of the present invention. Moreover, skilled artisans will appreciate that the principles of the present invention may be employed to ascertain and/or realize any number of other benefits associated with fuel mixing.

Fuel Cells

In the broadest sense, a fuel cell may be generally characterized as any device capable of converting the chemical energy of a supplied fuel directly into electrical energy by electrochemical reactions. This energy conversion corresponds to a free energy change resulting from an oxidation-reduction reaction, the oxidation of a supplied fuel coupled with ionic reduction of oxygen. A typical prior art fuel cell consists of an anode (e.g., ‘fuel electrode’) that provides a reaction site to generate electrons and protons and a cathode (e.g., ‘oxidant electrode’) to reduce spent fuel ions in order to produce a voltage drop across the external circuit. The electrodes are generally ionically porous electronic conductors that include catalytic properties to provide significant redox reaction rates. At the anode, incident hydrogen gas catalytically ionizes to produce protons (e.g., electron-deficient hydrogen nuclei) and electrons. At the cathode, incident oxygen gas catalytically reacts with protons migrating through the electrolyte and incoming electrons from the external circuit to produce water as a byproduct. Depending on various operational parameters of the fuel cell, byproduct water may remain in the electrolyte, thereby increasing the volume and diluting the electrolyte, may be discharged from the cathode as vapor, or stored in a reservoir for later use. The anode and cathode are generally separated by an ion-conducting electrolytic medium (i.e., PEM's or alkali metal hydroxides such as, for example: KOH, NaOH and the like). In early fuel cell experiments, hydrogen and oxygen were introduced into compartments and respectively while the electrodes, where conductively coupled by an external circuit to power a load where electrical work could be accomplished. In the external circuit, electric current is generally transported by the flow of electrons, whereas in the electrolyte, current is generally transported by the flow of ions. In theory, any chemical substance capable of oxidation (i.e., hydrogen, methanol, ammonia, hydrazine, simple hydrocarbons, and the like) which may be supplied substantially continuously may be used as galvanically oxidizable fuel at the anode. Similarly, the oxidant (i.e., oxygen, ambient air, etc.) may be selected to be any substance that can oxidize spent fuel ions at a sufficient rate to maintain a suitable voltage drop across the external circuit.

One process for fueling a hydrogen cell comprises that of ‘direct oxidation’ methods. Direct oxidation fuel cells generally include fuel cells in which an organic fuel is fed to the anode for oxidation without significant pre-conditioning or modification of the fuel. This is generally not the case with ‘indirect oxidation’ (e.g., “reformer”) fuel cells, wherein the organic fuel is generally catalytically reformed or processed into organic-free hydrogen for subsequent oxidation. Since direct oxidation fuel cells do not generally require fuel processing, direct oxidation provides substantial size and weight advantages over indirect oxidation methods. See, for example, in U.S. Pat. Nos. 3,013,908; 3,113,049; 4,262,063; 4,407,905; 4,390,603; 4,612,261; 4,478,917; 4,537,840; 4,562,123; 4,629,664 and 5,599,638.

Another well-known type of fuel cell component is known as a ‘membrane-electrode assembly’ (MEA), as generally described for example in U.S. Pat. No. 5,272,017 to Swathirajan. One exemplary embodiment of such an MEA component includes a Direct Methanol Fuel Cell which comprises a thin, proton-transmissive, solid polymer-membrane electrolyte having an anode on one of its faces and a cathode on an opposing face. The DMFC MEA anode, electrolyte and cathode may also be sandwiched between a pair of electrically conductive elements which serve as current collectors for the anode and cathode respectively and contain appropriate channels and/or openings for generally distributing the fuel (i.e., methanol and water, in the case of a DMFC device) and oxidant reactants (i.e., oxygen) over the surfaces of the corresponding electrode catalyst. In practice, a number of these unit fuel cells may be stacked or grouped together to form a ‘fuel cell stack’. The individual cells may be electrically connected in series by abutting the anode current collector of one cell with the cathode current collector of a neighboring unit cell in the stack.

As the DMFC anode is fueled with a mixture of methanol and water, the oxidation reaction generally proceeds in three steps: (1) methanol oxidizes to methanal (e.g., formaldehyde), releasing two electrons; (2) methanal oxidizes to methanoic acid (e.g., formic acid), releasing two electrons; and (3) methanoic acid oxidizes to carbon dioxide, releasing another two electrons. In various embodiments of exemplary DMFC's, the oxidation reaction may be started at any point in the multi-step series since the two intermediates (methanal and methanoic acid) are generally readily obtainable. It is generally believed, however, that the first oxidative step (methanol to methanal) is the rate-determining step of the overall reaction given spectroscopic studies indicating that methanal and methanoic acid appear in relatively low concentrations. This would generally suggest that the intermediates are rapidly oxidized and accordingly, the reaction steps corresponding to their oxidative consumption would be expected to have larger kinetic rate constants. The net anode reaction for a direct methanol-fueled device is therefore generally given as:
CH₃OH+H₂O→6H⁺+6e⁻+CO₂

Typically, the current produced by a DMFC is proportional to the net reaction rate, wherein one ampere corresponds approximately to 1.04E18 reactions per second. As aqueous methanol is oxidized at the anode, electrons are liberated to flow through an external circuit to power a load where electrical work may be accomplished. Protons migrate through the proton-transmissive electrolytic membrane where they subsequently are combined with oxygen that has been reduced with incoming electrons from the external circuit with water formed as a result. Since in DMFC, the power generation process in the anode side uses one water molecule for every methanol molecule, without recycling water, the maximum energy density of the fuel cartridge is 4780 Wh/L*62%=3320 Wh/L (4780 Wh/L is the energy density of pure methanol). In order to achieve maximum energy density, we have to use pure methanol as basic fuel. To do that, we have to be able to recover the water produced as a by-product of the power generation process and dilute pure methanol into 3-6% fuel. Besides fuel cell and fuel tank, the system needs various auxiliaries including two liquid pumps, one air pump, a methanol sensor and a mixing chamber, which often called the balance of plant (BOP) to support the operation. In the system, pure methanol fuel is diluted inside a mixing chamber by mixing pure methanol with returned fuel from the anode and water collected at the cathode. The methanol concentration in the mixing chamber is monitored at all times by a methanol sensor and controlled by a fuel injection method. Diluted fuel is provided to the anode by a liquid pump. The air is supplied to the cathode by an air pump. The electronics includes the power management, power conditioning, pump drivers, startup circuit, and fuel cell protection. Because we use 100% methanol as refillable fuel, this system has the potential to achieve high energy density.

Fuel Mixing

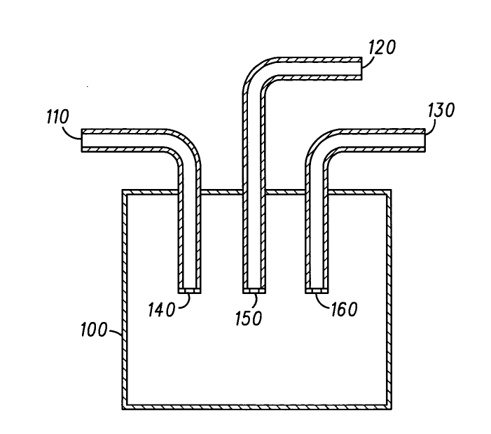

In accordance with an exemplary embodiment of the present invention, as representatively illustrated, for example, in FIG. 1, a system designed to mix and diluted a fuel stream for use in a DMFC is disclosed. Such a system may comprise: a pure fuel inlet 110 which delivers substantially pure MeOH into fuel mixing chamber 100 through fuel opening 140; a bubbling line inlet 120 which delivers a gas into fuel mixing chamber 100 through bubbling opening 150; and a diluted fuel outlet 130 which transports dilute aqueous MeOH out of fuel mixing chamber 100 for use by an external fuel cell stack through fuel outlet opening 160. (need to add a returned fuel line here too). In operation, the gaseous and aqueous output from the fuel cell anode and/or cathode is generally introduced into fuel mixing chamber 100 through the bubbling line (Can we use a better term to replace bubbling line?) in such a fashion that the turbulent bubbling action that results operates to mix and dilute the reservoir fuel contained therein. This mixing method consumes little power and can quickly dilute pure methanol with the returned fuel and fuel in the mixing chamber.

Periodic measurement, with integrated fuel concentration sensors for example, may be employed to actuate release of undiluted fuel through pure fuel line 110 if the concentration of diluted fuel drops below a certain threshold value and/or to terminate delivery of pure fuel if the concentration of diluted fuel becomes higher than another value. In an exemplary application using a device in accordance with an exemplary embodiment of the present invention, MeOH concentration was maintained within a range of variation on the order of about 3-6% that was observed over a period of more than about 700 hours. Skilled artisans will appreciate that various other geometries, other than those depicted or otherwise described herein, may be employed to obtain a substantially similar result or otherwise may be configured to permit effective mixing within the fuel reservoir chamber regardless of how the component system or device is oriented with respect to gravity.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components of any or all the claims.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

1. A device for mixing diluted fuel in a fuel cell; said device comprising:
a fuel mixing chamber;
a undiluted fuel inlet line for delivering substantially undiluted fuel into said mixing chamber;
a bubbling line for bubbling a gas into said mixing chamber, wherein said bubbling line comprises a return air/water line from at least one of an anode and a cathode of said fuel cell; and
a diluted fuel outlet line for transporting diluted fuel to an external fuel cell stack.

2. The device of claim 1, wherein said undiluted fuel comprises substantially pure MeOH.

3. The device of claim 2, wherein said diluted fuel comprises at least partially diluted aqueous MeOH.

4. The device of claim 1, further comprising a sensor for determining fuel concentration is said mixing chamber.

5. The device of claim 4, wherein said sensor is responsive to MeOH concentration.

6. The device of claim 1, further comprising a gas permeable membrane.

7. A method for mixing diluted fuel in a fuel cell device; said method comprising the steps of:
providing a fuel mixing chamber;
providing a undiluted fuel inlet line for delivering substantially undiluted fuel into said mixing chamber;
providing a bubbling line for bubbling a gas into said mixing chamber, wherein said bubbling line comprises a return air/water line from at least one of an anode and a cathode of said fuel cell; and
providing a diluted fuel outlet line for transporting diluted fuel to an external fuel cell stack.

8. The method of claim 7, wherein said undiluted fuel comprises substantially pure MeOH.

9. The method of claim 8, wherein said diluted fuel comprises at least partially diluted aqueous MeOH.

10. The method of claim 7, further comprising the step of providing a sensor for determining fuel concentration in said mixing chamber.

11. The method of claim 10, wherein said sensor is responsive to MeOH concentration.

12. The method of claim 7, further comprising the step of providing a gas permeable membrane.

13. The method of claim 7, further comprising the step of turbulently mixing said diluted fuel by bubbling gas into said mixing chamber.

14. The method of claim 7, further comprising the step of actuating delivery of undiluted fuel to said mixing chamber.

15. The method of claim 7, further comprising the step of terminating delivery of undiluted fuel to said mixing chamber.

16. A device for mixing diluted MeOH fuel in a DMFC; said device comprising:
a fuel mixing chamber;
a undiluted MeOH inlet line for delivering substantially undiluted MeOH into said mixing chamber;
a bubbling line for bubbling air into said mixing chamber, wherein said bubbling line comprises a return air/water line from at least one of an anode and a cathode of said DMFC;
a diluted MeOH outlet line for transporting diluted fuel to an external fuel cell stack; and
a sensor for determining MeOH concentration in said mixing chamber

17. The device of claim 16, further comprising a gas permeable membrane.
